(19) United States
(12) Patent Application Publication
(10) Pub. No.: US 2012/0198804 A1
(43) Pub. Date: Aug. 9, 2012

(54) HVAC Air Filter with Peel Layers

(76) Inventor: Stewart Kaiser, Boca Raton, FL (US)

(21) Appl. No.: 13/023,634

(22) Filed: Feb. 9, 2011

(51) Int. Cl. B01D 46/52; B23P 11/00

(52) U.S. Cl. 55/486; 29/428

(57) ABSTRACT

The invention is directed toward an HVAC air filter having peel layers so as to reduce the need for frequent changing of the air filter by increasing its lifespan. Such air filter first includes a rectangular exterior housing having a top and bottom side. Positioned between both sides are a plurality of corrugated filter sheets, each filter sheet being MERV 4 compliant. Preferably, the air filter includes a first sheet, a second sheet, and a corresponding third sheet each mirroring the size and orientation. Positioned between the third sheet and the bottom side of the exterior housing is additional filter media to aide in filtration. Preferably, each filter sheet includes a pull or tab at the distal end to aide in peeling away each sheet to expose the sheet below.

### FIELD OF THE INVENTION

This invention is directed toward an air filter for use in both commercial and residential air conditioning and heating (HVAC) systems which includes two or more peel layers to increase the lifespan of the air filter, thereby reducing the need for frequent replacement.

### BACKGROUND OF THE INVENTION

Air filters find common use in a variety of mechanical systems, including both the automotive and the residential heating and air conditioning applications. Regardless of application, these devices employ fibrous materials which allow air to pass through the filter while removing solid particulates such as dust, pollen, mold and bacteria. In addition, air filters may include an absorbent or catalyst for removal of airborne molecular contaminants such as volatile organic compounds, ozone or other biologics.

Air filters come in a variety of shapes and housing, depending upon their use. Likewise, materials used for air filters are often depending upon their application. Examples include foam, pleated paper, cotton, or spun fiberglass as commonly used filter elements. Often these materials may include static electric charges to attract dust particles.

Air filters constitute an important component to any residential or commercial air conditioning, ventilating and heating (HVAC) system. This is primarily due to the large volume of potentially harmful organics that may accumulate in a home or office due to the circulation of air—which includes dirt, dust, hair, dander, pollen, pet bi-products, and off-gasses due to food and other house wares.

The entry of any of these particulates into an HVAC system first results in lower efficiencies in the duct work. However, long term entry of these biologics can cause escalation of mold and pathogen grown within the entire HVAC system which may lead to adverse health risks. This in turn may lead to chronic sickness (including coughing, frequent sneezing, eye irritation), respiratory infection and related illness. The end result is loss of work and reduced enjoyment of the facility.

To prevent accumulation of these various pathogens within an HVAC system, several forms of air filters have been developed for heating and air conditioning system application. One such example is found in U.S. Pat. No. 3,494,113 to W. L. Kinney issued on Feb. 10, 1970. The Kinney patent teaches a rectangular air filter that includes a series of pleated filter assemblies through use of wire reinforced grids and use of filter media. These corrugated pleats function to increase the surface are of the filter, to provide more effective treatment of the air when passing through the grids and contacting the filter media.

Yet another design for air filters for use in HVAC systems is taught by U.S. Pat. No. 5,354,365 to Youn issued on Oct. 11, 1994. The Youn Patent teaches away from corrugated pleats and instead teaches use of parallel elongated semi-cylindrical surfaces which form voids to maintain filter media. Positioned within these voids is a selection of varying gas absorbing materials such as activated charcoal, activated alumina, silica gel or filter material.

While these filter assemblies help create arrangements to maximize contact between a filter media and the air, they have multiple limitations. One of the most significant is the need to replace these filters at least every two to three months, depending upon use, size of the home (or office) and the number of filters placed throughout the HVAC systems. As such air filters can cost between $8.00 to $18.00, this can become an expensive cost to maintain an HVAC system.

In addition to cost, another limitation is that replacing an air filter is time consuming and cumbersome. As many such air filters are positioned in hard to reach ceilings, they require a ladder or other equipment to change and replace. This especially rings true with new constructed homes, as they often have high ceilings which require even more effort to change air filters.

Although there have been many advances in the design of filter media for use with air filters in HVAC Systems, little has been done to increase the lifespan of these air filters. Accordingly, there is a need in the air of HVAC air filters for a long lasting and effective air filter that reduces the need to change the entire filter.

### BACKGROUND OF THE INVENTION

The foregoing invention solves many of the current limitations found in air filters used in commercial and residential HVAC systems. Moreover, the invention allows for a longer life air filter, that is more easily maintained and served—such that it needs replaced once a year (rather than once every three months). This in turn creates a filter that saves not only money, but also the time necessary to completely replace prior devices.

The air filter of the present invention is essentially of two part construction: having a rectangular exterior housing which maintains a plurality of filter layers. Such exterior housing may include a first end, a second end, a top end, a bottom end, a top side and a bottom side. Positioned on the front side are a plurality of labels sufficient to record data such as the date installed and replacement date for the air filter.

Positioned between the top side and bottom side of the exterior housing are a plurality of corrugated filter sheets, where each sheet is MERV 4 compliant. Preferably, the air filer includes a first sheet, a second sheet, and a corresponding third sheet each mirroring the size and orientation. Positioned between the third sheet and the bottom side of the exterior housing is additional filter media to aide in filtration. Preferably, each filter sheet includes a tab at the distal end to aide in peeling away each sheet to expose the sheet below.

In addition to the apparatus, the invention is further directed to a method of filtering air to be introduced within an HVAC system. The first step includes affixing the air filter within the HVAC System. After a prescribed period of time, the method next contemplates engaging a first tab positioned at the distal end of the first sheet. Upon engaging the first tab, the next step is to peel the first sheet away from the exterior housing. This in turn exposes a second sheet located within the exterior housing which was positioned previously below the first sheet. After a second period of time, the method calls for ripping the second sheet away from the exterior housing through use of a second tab. This will expose the third sheet within the exterior housing which was positioned previously below the second sheet. After a third prescribed period of time, the entire air filter should be removed and replaced.

### BRIEF DESCRIPTION OF THE INVENTION

For a fuller understanding of the invention, reference is made to the following detailed description, taken in connection with the accompanying drawings illustrating various embodiments of the present invention, in which:

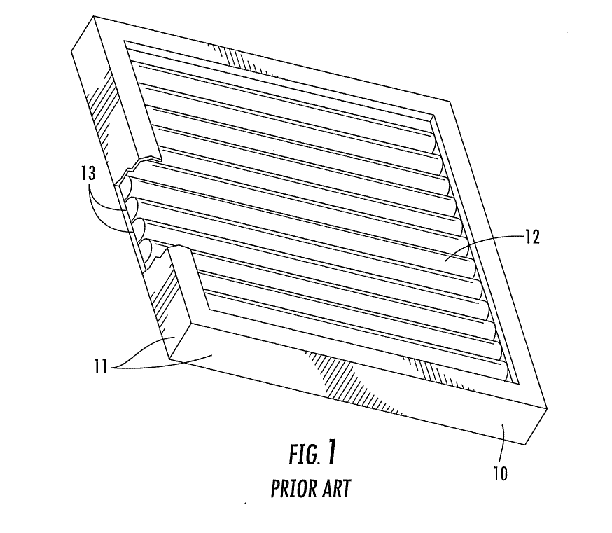

FIG. 1 is a perspective view that illustrates a prior art air filter;

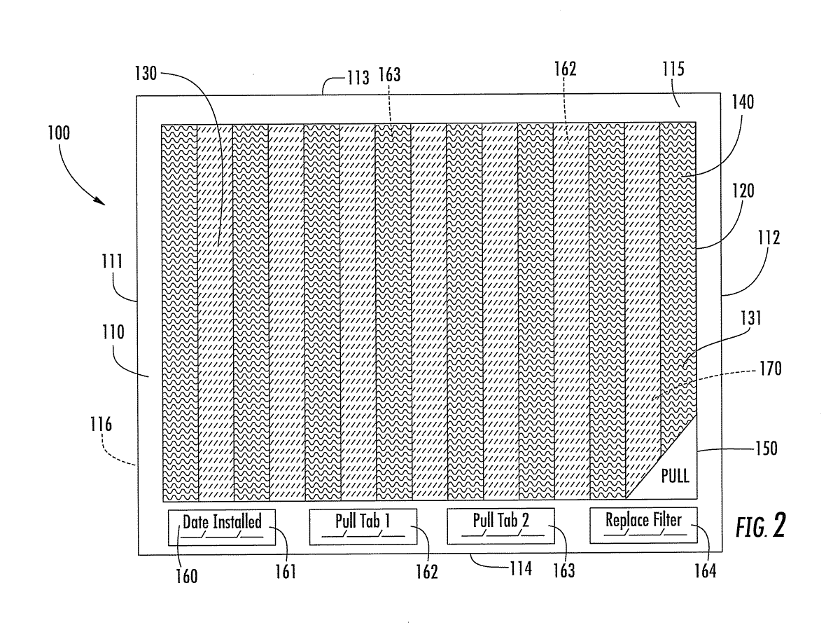

FIG. 2 is a front view of the air filter of the present invention which illustrates its corrugated peel layers;

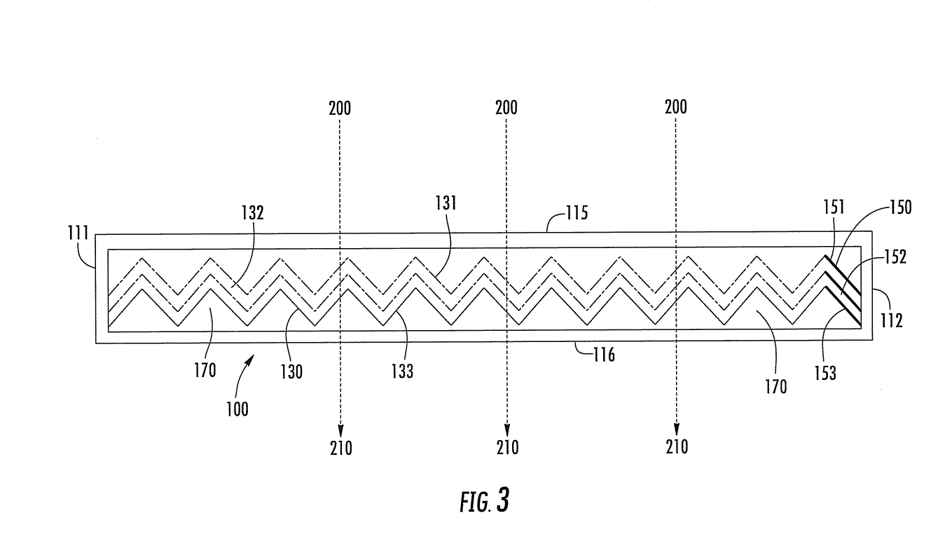

FIG. 3 is a cut-away side view of the air filter further illustrating three corrugated peel layers;

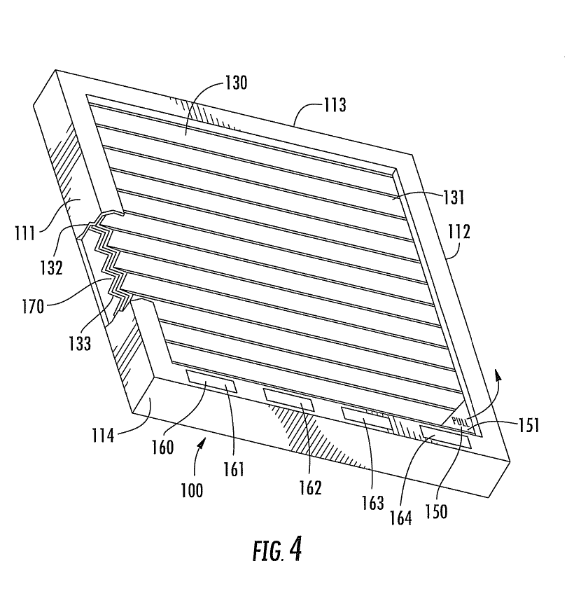

FIG. 4 is a perspective view of the air filter which shows the various corrugated peel layers as well as a pull or tab; and

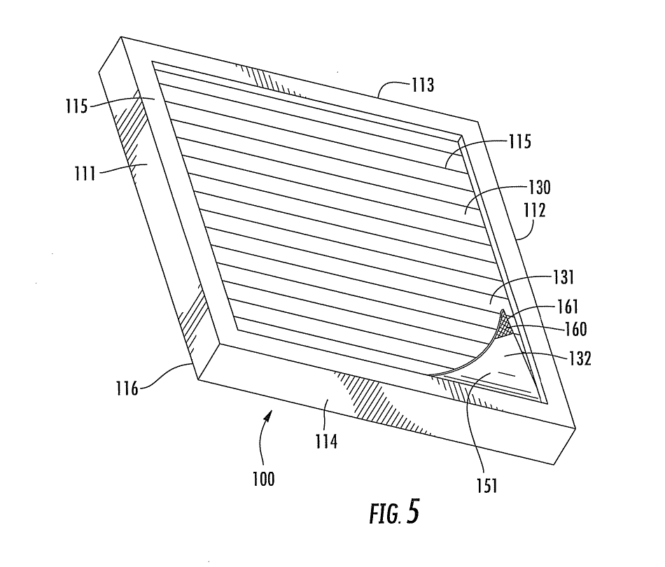

FIG. 5 is a perspective view of the air filter where a first pull tab was used to separate the first filter layer from the air filter.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Prior Art Air Filters

FIG. 1 illustrates, by way of example, an existing state of the art air filter 10. As shown, the air filter 10 is essentially rectangular in shape and cross section. The air filter 10 has essentially two primary components: an outer frame 11 and filter media 12. As shown, the filter media 12 is encased through a wire mesh or fiberglass matrix. As air flows thought the wire mesh of the air filter 10, it engages the filter media 12 which in turn prevents dust, dander or other particulates from getting inside an HVAC system.

Existing air filters 10 vary in size and shape based upon the requisite openings found throughout an HVAC system. The most typical air filter 12 requires that the outer frame 11 be 12 inches wide by 12 inches long by 2 inches thick. Most outer frames 11 are made of cardboard or similar lightweight material.

### Exterior Housing of the Air Filter

FIGS. 2 through 5 illustrate, by way of example, one embodiment of the invention which includes an air filter 100. FIG. 2 first shows the exterior housing 110 of the air filter 100. Such exterior housing 110 is preferably made of a light weight, biodegradable material made of a cellulosic material, recycled paper or plastic, or alternatively a composite. However, the exterior housing 110 should have properties which make it less susceptible to growth of mold or pathogens.

As further illustrated in FIG. 2, the exterior housing 110 is preferably square or rectangular in shape. As such, the exterior housing 110 includes a first side 111 and a second side 112—both of which are parallel to each other. Correspondingly, the exterior housing 110 also has a top side 113 and corresponding bottom side 114 that are also in parallel relation to each other. Each of the four sides 111-114 of the exterior housing 110 are a sufficient size and dimension to be secured within a traditional HVAC system.

Positioned and maintained within the exterior housing 110 shown in FIG. 2 are a plurality of filter sheets 130. While the air filter 100 may include any number of given filter sheets 130: the technology specifically contemplates three layers 140 of filter sheets 130 (a first sheet 131, a second sheet 132, and a third sheet 133, as illustrated with reference to FIG. 3).

As further shown in FIG. 2, the top 113 of the exterior housing 110 may include recording labels 160 for purposes of denoting the time in which the air filter 100 was installed as well as when given filter sheets 130 were removed. More specifically, a first label 161 records when the air filter 110 was first installed within the HVAC system. Such first label 161 includes a portion to record this information for later review. The second label 162 records when the first label 161 was removed, while a third label 163 similarly records when the second label 162 is torn away from the air filter 100. A fourth label 164 denotes the proper date when the entire air filter 100 should be removed and replaced.

### The Filter Layers

FIG. 3 represents a cut away view of the air filter 100 which shows the orientation and positioning of the various filter layers 140 within the exterior housing 110. FIG. 3 first shows the cross section of the exterior housing 110 which includes the first side 111, the corresponding second side 112, the top side 115 and the corresponding bottom side 116—all which form a rectangular assembly, as described with reference to FIG. 2.

Positioned within the rectangular assembly created by these various sides 111, 112, 115, and 116 are the plurality of filter sheets 130. As shown, each filter sheet 130 is pleated and corrugated such that it maximizes its surface area between the first side 111 and second side 112 of the exterior housing 110. By increasing such surface area, the filter sheet 130 will have a longer lifespan and allow for great contact with unfiltered air 200.

Preferably, each filter sheet 130 is made of MERV 4 (Minimum Efficiency Reporting Value) material, such that it sufficiently may remove pollen, moss, dust mites, spray paint dust, textile or carpet fibers from the incoming unfiltered air 200. Materials contemplated for each respective filter sheet 130 include any form of disposable fiberglass or synthetic mesh material. This may include but is not limited to an aluminum mesh latex coated material. Moreover, each filter sheet preferably includes an electro-statically charged woven polycarbonate material.

As further shown in FIG. 3, there are three principal filter sheets 130: the first sheet 131, the second sheet 132, and the corresponding third sheet 133, as earlier described. Each sheet 131-133 mirrors the other in shape, size and orientation such that they may be placed on top of one other. Accordingly, each sheet 131-133 is corrugated and pleated to mirror one another. Through placing three filter sheets 130 on top of one another, the total filtration capability of a new air filter 110 qualifies as MERV 12, which is sufficient to filter legionella, lead dust, milled flour, and nebulizer drops from the untreated air 200. Put another way, placement of three filter sheets 130 within the exterior housing 110 is sufficient to employ the air filter 100 in hospital laboratories.

Located at the distal end of each filter sheet 130 is a pull or tab 150 (as shown in FIGS. 3 and 4). More specifically, the first sheet 131 includes a first pull or tab 151, the second sheet 132 includes a second pull or tab 152 and a third sheet 133 includes a third pull or tab 133. By engaging a respective pull or tab 150, the filter sheet 130 becomes dislodged from the exterior housing and may be peeled off the air filter 100. Put another way, by engaging the first pull or tab 151 (shown in FIG. 5) to peel away the first sheet 131, the air filter will then employ both the second and third sheets 132 and 133 to filter particulates and airborne biologics.

Optionally (and again with reference to FIG. 4) positioned below the third sheet 133 is filter media 170. Such filter media 170 is sandwiched between the filter sheets 130 and the bottom side 116 of the exterior housing 110. Such filter media 170 is preferably some form of activated carbon or aluminum. Combination of the filter media 170 and the various filter layers 140 act to effectively filter air 210 for introduction into the HVAC system.

### Method of Use

In addition to the apparatus described above, the invention is also directed to a method of using the air filter 100. The first step includes affixing the air filter 100 within the HVAC System. After a prescribed period of time, the method next contemplates engaging a first tab positioned at the distal end of the first sheet.

Upon engaging the first pull or tab 151, the next step is to peel the first sheet 131 away from the exterior housing 110. This in turn exposes a second sheet 132 located within the exterior housing 110 which was positioned previously below the first sheet 131. After a second period of time, the method calls for ripping the second sheet 132 away from the exterior housing 100 through use of a second pull or tab 152. This will expose the third sheet 133 the exterior housing 110 which was positioned previously below the second sheet 132.

After a third prescribed period of time, the entire air filter 100 should be removed and replaced.

I claim:

1. An air filter, comprising:
an exterior housing having a top side and an opposing bottom side;
two or more filter sheets positioned between the top and bottom sides of the exterior housing, wherein each filter sheet mirrors the size and orientation of an adjacent filter sheet; and
filter media positioned between filter sheets and the bottom side of the exterior housing.

2. The air filter of claim 1, wherein each of the filter sheets include a first sheet, a second sheet and a corresponding third sheet; and wherein each filter sheet is in parallel relationship to one another.

3. The air filter of claim 2, wherein each filter sheet is corrugated in shape.

4. The air filter of claim 2, wherein a distal end of each filter sheet includes a tab positioned for peeling away the filter sheet from the exterior housing.

5. The air filter of claim 1, wherein the exterior housing is rectangular in shape.

6. The air filter of claim 2, wherein each filter sheet is made of a MERV 4 grade filter material.

7. An air filter, comprising:
an exterior housing having a top side and a bottom side; and
three corrugated filter sheets positioned between the top and bottom side of the exterior housing, wherein each filter sheet mirrors the size and orientation of the other filter sheets.

8. The air filter of claim 7, further comprising a filter media positioned between the three filter sheets and the bottom side of the exterior housing.

9. The air filter of claim 7, wherein a distal end of each filter sheet includes a tab which may be used to peel away the filter sheet from the exterior housing.

10. The air filter of claim 7, wherein the exterior housing is rectangular in shape.

11. The air filter of claim 7, wherein each filter sheet is made of a MERV 4 grade filter material.

12. A method of filtering air to be introduced within an HVAC system, comprising the steps of:
(a) affixing an air filter within the HVAC system, the air filter having an exterior housing with both a top side and a bottom side, and three corrugated filter sheets positioned between the top and bottom side of the exterior housing, wherein each filter sheet mirrors the size and orientation of the other filter sheets;
(b) engaging a first tab positioned at the distal end of a first filter sheet;
(c) peeling a first corrugated filter sheet away from the exterior housing; and
(d) exposing a second corrugated filter sheet located within the exterior housing which was positioned previously below the first sheet.

13. The method of claim 12, further comprising the steps of:
(e) peeling the second corrugated filter sheet away from the exterior housing through use of a second tab; and
(f) exposing the third corrugated filter sheet within the exterior housing which was positioned previously below the second sheet.

14. The method of claim 13, wherein filter media is positioned between the third filter sheet and the bottom side of the exterior housing.

15. The air filter of claim 12, wherein the exterior housing is rectangular in shape.

16. The air filter of claim 12, wherein each filter sheet is made of a MERV 4 grade filter material.
